(19) United States
(12) Patent Application Publication
(10) Pub. No.: US 2006/0199727 A1
(43) Pub. Date: Sep. 7, 2006

(54) Supported olefin polymerization catalysts

(76) Inventors: Maurice S. Brookhart, Chapel Hill, NC (US); Henri Stephan Schrekker, Porto Alegre - RS (BR); Joel D. Citron, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/367,639

(22) Filed: Mar. 3, 2006

Related U.S. Application Data
(60) Provisional application No. 60/658,542, filed on Mar. 4, 2005.

(51) Int. Cl. B01J 31/00

(52) U.S. Cl. 502/103; 502/117; 502/152; 526/172

(57) ABSTRACT

Certain Group 8-10 transition metal complexes of bidentate ligands can be supported on hydroxyl containing supports which have been treated with certain organometallic compounds. These olefin polymerization catalyst precursors can be activated for olefin polymerization by contacting them with specific types of compounds to form olefin polymerization catalysts. Olefins which may be polymerized include ethylene and certain polar comonomers. The polyolefins produced are useful, for example, as films for packaging and as molding resins.

### FIELD OF THE INVENTION

A supported polymerization catalyst precursor is made by reacting certain organometallic compounds with an inorganic oxide or a polymer having hydroxyl groups, and contacting that material with certain complexes of a neutral bidentate ligand of a Group 8-10 transition metal. The supported unactivated polymerization catalyst may be activated for polymerization by contact with certain activators such as selected organoaluminum compounds.

### BACKGROUND

The use of late transition metal complexes to catalyze olefin polymerizations, especially (co)polymerization of ethylene, became of great interest with the discovery by Brookhart and Johnson of the use of Ni and Pd complexes of α-diimines and other bidentate ligands to (co)polymerize olefins. Much work has subsequently been done on these and other late transition metal complexes as olefin polymerization catalysts.

In commercial polymerization of olefins, and especially of ethylene homopolymers and copolymers, a variety of polymerization processes have been developed. Among these are gas phase, slurry, suspension and solution processes. Some of these usually use a polymerization catalyst system in which the actual polymerization catalyst is supported in some way on a solid support, such as silica, alumina, a polymer, magnesium chloride, etc. Many methods have been developed to support such catalysts. In gas phase polymerizations, although the polymerization catalyst may be chemically bound to the support, such attachment may not be necessary since the catalyst itself will not be dissolved and removed from the support. On the other hand, when the polymerization is carried out in a liquid medium such as in a slurry or suspension polymerization, firmer attachment of the polymerization catalyst to the support, e.g., via covalent or ionic bonds, may be desirable, since otherwise the liquid medium may remove the catalyst from the support.

Methods for supporting late transition metal catalysts have been developed. In some instances the catalyst may be bound to a support such as silica by reacting a complex (more accurately an anionic group, such as a halide, coordinated to the transition metal) with an organometallic compound such as an alumoxane, to form a fully activated (for polymerization) catalyst, wherein the complex is attached to the support, presumably by ionic bonding between the support and the transition metal complex. This type of supported catalyst sometimes has the disadvantage of losing activity while being stored.

Complexes of neutral bidentate ligands of Group 8-10 transition metal complexes wherein the ligand contains a particular functional group for supportation of the complex through a covalent bond, and supportation thereof, have been disclosed. in U.S. Pat. No. 6,410,768, U.S. Pat. No. 6,586,358, and U.S. Patent Application 2002/01187892. The ligands used in the complexes disclosed herein do not contain such a functional group.

Activated supported polymerization catalysts derived from complexes of Group 8-10 transition metals and neutral bidentate ligands have been made by contacting a trialkylaluminum compound with the complex, and a support which itself contains substances which together with the other ingredients directly form an activated supported catalyst, see U.S. Pat. No. 6,184,171, U.S. Pat. No. 6,399,535 and U.S. Pat. No. 6,686,306. Such other ingredients in the support are termed “support-activators”.

Supportation of complexes of neutral bidentate ligands is disclosed in U.S. Pat. No. 5,880,241 and U.S. Pat. No. 6,194,341, which disclose supportation using an activating aluminum compound such as methylalumoxane to directly form an activated supported polymerization catalyst.

New polymerization catalysts for polymerization of olefins, particularly ethylene, are desired. The present invention provides new supported polymerization catalysts that can be made without support activators and are not initially activated upon formation.

### SUMMARY OF THE INVENTION

One aspect of the present invention is a process for the formation of a supported olefin polymerization precursor, comprising contacting an organometallic compound of the formula R¹ₙM, a support which is an inorganic oxide having hydroxyl groups or an organic polymer having hydroxyl groups, and a complex of a Group 8-10 transition metal, with a bidentate ligand that when activated forms an active olefin polymerization catalyst, wherein:
each R¹ is independently hydrogen, hydrocarbyl or substituted hydrocarbyl;
n is an integer of 2 to 4 and is the oxidation state of M; and
M is a metal;

and provided that:
said neutral bidentate ligand does not contain a functional group which readily reacts with said organometallic compound;
said support does not contain a support-activator;
and said precursor is not activated.

In some embodiments, the process further includes activating the precursor.

In some embodiments, the process still further includes polymerization of one or more olefins using the activated precursor as a polymerization catalyst.

### DETAILED DESCRIPTION

The following terms, as used herein, have the meanings set forth below unless otherwise defined.

A “hydrocarbyl group” is a univalent group containing only carbon and hydrogen. Examples of hydrocarbyls include unsubstituted alkyls, cycloalkyls and aryls. If not otherwise stated, it is preferred that hydrocarbyl groups herein contain 1 to about 30 carbon atoms.

By “substituted hydrocarbyl” herein is meant a hydrocarbyl group that contains one or more (types of) substituents that do not substantially interfere with the operation of the polymerization catalyst system. Suitable substituents in some polymerizations may include some or all of halo, ester, keto (oxo), amino, imino, carboxyl, phosphite, phosphonite, phosphine, phosphinite, thioether, amide, nitrile, silane, and ether. Preferred substituents when present are halo, ester, amino, imino, carboxyl, phosphite, phosphonite, phosphine, phosphinite, thioether, silane, ether and amide. Which substituents are useful in which polymerizations can in some cases be determined by reference to U.S. Pat. No. 5,880,241 (incorporated by reference herein for all purposes as if fully set forth). If not otherwise stated, it is preferred that substituted hydrocarbyl groups herein contain 1 to about 30 carbon atoms. Included in the meaning of “substituted” are chains or rings containing one or more heteroatoms, such as nitrogen, oxygen and/or sulfur, and the free valence of the substituted hydrocarbyl may be to the heteroatom. In a substituted hydrocarbyl, all of the hydrogens may be substituted, as in trifluoromethyl.

By “inert functional group” herein is meant a group other than hydrocarbyl or substituted hydrocarbyl that is inert under the process conditions to which the compound containing the group is subjected. Inert functional groups also do not substantially interfere with any process described herein, and especially do not readily react with the organometallic compound. Examples of functional groups include some halo groups (for example, fluoro, some unactivated chloro, and fluoroalkyl) and ethers such as —OR²² wherein R²² is hydrocarbyl or hydrocarbyl substituted with an inert functional group. When the functional group is near the transition metal atom of the bidentate complex, the functional group preferably does not coordinate to that metal atom more strongly than do the groups in those compounds that are shown as coordinating to the metal atom. It is highly preferred that the inert functional groups do not displace the desired coordinating groups.

By an “activator”, “cocatalyst” or a “catalyst activator” is meant a compound that reacts with a transition metal compound to form an activated catalyst. The transition metal compound can be added directly, or can be formed in situ, as by reaction of a transition metal compound with an oxidizing agent. A preferred catalyst activator is an “alkyl aluminum compound”, that is, a compound having at least one alkyl group bound to an aluminum atom. Groups such as alkoxide, hydride, oxygen, and halogen can also be bound to aluminum atoms in the compound.

By a “support-activator” is meant a group that is attached to or incorporated into the support and that, when contacted with the organometallic compound and the Group 8-10 transition metal complex activates the complex for olefin polymerization. Such materials and methods for attaching or incorporating into the support are disclosed, for example in U.S. Pat. No. 6,184,171, U.S. Pat. No. 6,399,535 and U.S. Pat. No. 6,686,306, the disclosures of which are hereby incorporated herein by reference in their entirety.

By “activate” or “activated” herein is meant that a material containing the Group 8-10 transition metal complex of a bidentate ligand will cause the polymerization of an olefin that can normally be polymerized by such a complex (when in its activated form). If there is any doubt as to whether a complex is active or has been activated, it can be contacted with ethylene (at a partial pressure of about 0.7 to about 3.5 MPa) to determine if significant amounts are polymerized. The formation of relatively small amounts of polyethylene does not indicate an activated polymerization catalyst, since other ingredients that may be present (such as the organometallic compound) can cause very slow polymerization of ethylene by themselves.

“Alkyl group” and “substituted alkyl group” have their conventional meanings that are well known to those skilled in the art. The term “substituted” in “substituted alkyl” has the same meaning as that set forth hereinabove regarding “substituted hydrocarbyl”. Unless otherwise stated, alkyl groups and substituted alkyl groups preferably have 1 to about 30 carbon atoms.

By a “heteroatom connected monovalent radical” is meant a substituted hydrocarbyl that is a monovalent radical or group that is connected to the rest of the compound through a valence of a heteroatom (an atom other than C or H). The group can have a formal valence greater than one if it is part of a ring.

By “aryl” is meant a monovalent aromatic group in which the free valence is to a carbon atom or heteroatom of an aromatic ring. An aryl can have one or more aromatic rings that may be fused, connected by single bonds or other groups. The aromatic ring can contain heteroatoms, as in a 1-pyrrolyl aryl group.

By “substituted aryl” is meant a monovalent aromatic group substituted as set forth in the above definition of “substituted hydrocarbyl”. Similar to an aryl, a substituted aryl can have one or more aromatic rings that can be fused, connected by single bonds or other groups. However, when the substituted aryl has a heteroaromatic ring, the free valence in the substituted aryl group can be to a heteroatom (such as nitrogen) of the heteroaromatic ring instead of a carbon.

By a “neutral” ligand is meant a ligand that is electrically neutral, that is bears no charge. In other words, the ligand is not ionic.

By a “bidentate” ligand is meant a ligand that has two sites, often heteroatom sites that can coordinate to a transition metal atom simultaneously. Preferably both sites do coordinate to the transition metal.

Useful bidentate ligands can be found in previously incorporated U.S. Pat. No. 5,880,241, as well as in U.S. Pat. No. 5,932,670, U.S. Pat. No. 5,714,556, U.S. Pat. No. 6,103,658, WO9847934, WO9840420, WO0006620, WO0018776, WO0050470, WO0142557 and WO0059914, all of which are also incorporated by reference herein for all purposes as if fully set forth. The cited documents disclose transition metals useful with the bidentate ligands, and how to make complexes of the bidentate ligands with appropriate transition metals, and reference can be made thereto for further details.

The transition metal in the complex is chosen from Group 8-10 (IUPAC notation) of the periodic table. Preferred transition metals are Ni, Pd, Fe and Co, more preferably Ni and Pd, and especially preferably Ni.

One general formula for the Group 8-10 transition metal complex of the bidentate ligand is 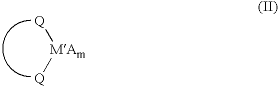
wherein 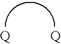
represents a neutral bidentate ligand, M′ is the Group 8-10 transition metal, each A is independently a monoanion (singly negatively charged ion), and m is the oxidation state of M′. In (II) it is preferred that all of A is the same. Useful monoanions include halide, especially chloride and bromide, carboxylate, alkoxide, thiolate, alkyl, and aryl. Halide and carboxylate are preferred, and chloride and bromide are especially preferred. Preferably none of A is relatively noncoordinating anions.

Suitable neutral bidentate ligands are represented by formula III 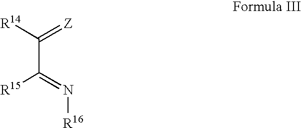
wherein
Z is O (oxygen) or N—R¹³;
R¹³, and R¹⁶ are each independently hydrocarbyl or substituted hydrocarbyl, provided that an atom bound to an imino nitrogen atom has at least two carbon atoms bound to it;
R¹⁴ and R¹⁵ are each independently hydrogen, hydrocarbyl, substituted hydrocarbyl, a heteroatom connected monovalent radical, or R¹⁴ and R¹⁵ taken together form a; and
the substituents of the substituted hydrocarbyl groups are selected from the group of inert functional groups.

A preferred neutral bidentate ligand is 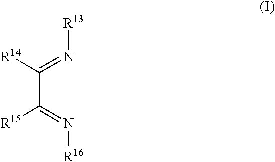
wherein:

R¹³ and R¹⁶ are each independently hydrocarbyl or substituted hydrocarbyl, provided that the atom bound to the imino nitrogen atom has at least two carbon atoms bound to it; and

R¹⁴ and R¹⁵ are each independently hydrogen, hydrocarbyl, substituted hydrocarbyl, a heteroatom connected monovalent radical, or an inert functional group. The substituents on the substituted hydrocarbyl group are inert functional groups. R¹⁴ and R¹⁵ taken together may form a ring.

Specific preferred compounds for (I) as well as preferred general formulas are disclosed in U.S. Pat. No. 5,880,241. For example it is preferred that R¹⁴ and R¹⁵ are both methyl, or both hydrogen, or taken together are 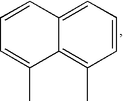
and/or R¹³ and R¹⁶ are each independently 2,6-disubstituted phenyl, and more preferably each of those 2 and 6 substituents are each independently alkyl or substituted alkyl containing 1 to 6 carbon atoms and halogen.

In other preferred forms of (I), R¹⁴ and R¹⁶ are each independently (diorthoarylsubstituted)aryl, that is R¹⁴ and R¹⁶ have aryl or substituted aryl groups in both ortho positions to the carbon atom bound to the imino nitrogen atom. It is even more preferred that R¹⁴ and R¹⁶ are 2,6-diaryl (or substituted diaryl)phenyl groups. Such preferred groups are disclosed in WO0050470, and WO1042257, which are hereby included by reference. Useful groups for R¹⁴ and R¹⁶ include groups such as 2,6-diphenylphenyl, 2,6-bis(2-methylphenyl)phenyl and 2,6-bis(4-t-butylphenyl)phenyl. In addition to the diortho substitution, other groups can also be substituted in any of the aryl rings.

The organometallic compounds, R¹ₙM, used herein include metals, M, whose oxidation state is two or more. Useful metals include Li, Mg, Zn, Al, B, and Si. Al is preferred. Preferably R¹ is hydrocarbyl, more preferably alkyl and substituted alkyl, and especially preferably alkyl containing 1 to 4 carbon atoms. Useful alkyl groups include methyl, ethyl, propyl, n-butyl, isobutyl and n-hexyl. Preferred alkyl groups are methyl, ethyl, n-butyl and isobutyl; methyl and ethyl are especially preferred, and methyl is most preferred. In another preferred form all of R¹ are the same. Specific useful compounds include diethyl zinc, diphenyl magnesium, bis(2-ethoxyethyl) magnesium, trimethylaluminum, triethylaluminum, tri-n-butylaluminum and triisobutylaluminum.

The support is a metal oxide or an organic polymer containing hydroxyl groups. Such an organic polymer includes for example a copolymer of styrene and p-hydroxystyrene, a copolymer of methyl methacrylate and 2-hydroxyethyl methacrylate, and cellulose or a partially etherified cellulose. The polymers may be crosslinked to make them insoluble in organic solvents.

The inorganic oxides can contain hydroxyl groups, particularly if they have not been heated to a high enough temperature for a sufficient time to dehydrate them after they have been formed. Some oxides may form hydroxyl groups on their surfaces after merely standing in moist air. Although these are not “pure” oxides in a strictly chemical sense, they are usually referred to as oxides even though hydroxyl groups are present. The metal oxides useful herein can be mixed with or reacted with other substances so long as the other substances are inert. It is preferred that such other substances are not support-activators, because it is desirable to have the precursor not be activated until it is to be used. It was surprisingly found that such precursors could be made according to the processes disclosed herein.

Suitable metal oxides also include mixed oxides such as silicates, which may be manmade or natural (minerals), provided that the mixed oxides are not inherently support-activators. Useful oxides include silica, alumina, and magnesium oxide. Preferred supports are metal oxides, and preferred oxides are silica and alumina. Silica is especially preferred.

The ratio of support to organometallic compound is not critical, but it is preferable that a molar excess of organometallic compound be used in relationship to the number of hydroxyl groups on support. Since the number of such hydroxyl groups, especially chemically available (for reaction) hydroxyl groups, may be difficult to determine, using a considerable excess of the organometallic compound is often desirable. The mixing of the support and organometallic compound is most conveniently carried out in a liquid medium. This liquid medium can be an inert organic solvent, e.g., a hydrocarbon such as pentane or toluene, or a halocarbon such as methylene chloride or chlorobenzene. Gentle mixing is preferred to avoid the formation of too many fine particles. The contacting can also be done with the organometallic compound in the gas phase (if it is volatile enough), or by contacting the neat liquid organometallic compound and the support.

The amount of Group 8-10 transition metal complex used depends on the concentration desired on the support (usually given as the percent by weight of transition metal present) and the maximum amount that can be supported. The latter can be determined by simple experimentation. For example, a solution of the metal complex, which is usually highly colored, is added to the R¹ₙM-treated support, to result in a colored support and a colored solution. The excess solution is filtered off and, after removing the solvent, the amount of metal complex transferred to the support is determined. Typically the amount of transition metal on the polymerization supports is about 0.05 to 3 weight percent, more typically about 0.2 to about 2.0 percent, measured as the transition metal (alone). The complex is typically contacted with the support in a liquid medium in which the complex is usually at least sparingly soluble.

Metal analyses are typically done by dissolving the supported catalyst (or supported catalyst precursor) under acid and/or basic conditions and then analyzing the resulting solution by inductively coupled plasma analysis.

The contacting of the support with the organometallic compound and the complex with the support can be carried out essentially simultaneously. Alternatively, the support can first be contacted with the organometallic compound, optionally filtered and excess (not attached to the support) organometallic compound washed away, and then the treated support contacted with the complex. The latter procedure is preferred. The treated support need not be dried before being contacted with the complex unless the solvent used in the first step is deleterious to the complex.

After the support has been contacted with the complex the supported catalyst precursor can be isolated and stored until it is activated for use as a polymerization catalyst, or it can activated and used immediately, even in the liquid medium in which it was formed. It is preferable to filter off the precursor and wash it with an inert solvent to remove complex that is not bound to the support. This is particularly appropriate if the catalyst is to be used in a slurry polymerization, since unbound complex can leach into the liquid medium of the slurry, thereby at least partially defeating the purpose of supporting the complex. For a gas phase polymerization, the precursor can merely be filtered, or the solvent removed under vacuum. For the purposes of achieving a desirable particle morphology in the gas phase polymerization process, it may be desirable to wash the precursor.

Whichever of the optional steps disclosed hereinabove is used, the precursor produced is substantially inactive for olefin polymerization by itself (i.e., without activation by a cocatalyst or activator). The precursor can be activated for polymerization by contacting it with a Lewis acid that is a stronger Lewis acid than the organometallic compound, R¹ₙM. Such stronger Lewis acids could include compounds such as AlCl₃ and BF₃, but more preferably are hydrocarbylaluminum compounds that also contain elements more electronegative than carbon (e.g., halogen or oxygen), which electronegative elements are bound to aluminum. Such compounds include dialkylaluminum halides, alkylaluminum dihalides, alkylaluminum sesquihalides, alkylalumoxanes, and (alkyl)(alkoxy)aluminum compounds. Specific useful compounds include methylalumoxane (MAO), n-butylalumoxane, diethylaluminum chloride, n-butylaluminum dichloride, ethylaluminum sesquichloride, diethylmethoxyaluminum, and ethylaluminiumdichloride. These are typically added so that the ratio of newly added Al to Group 8-10 transition metal is about 2 to 1000, more typically about 5 to about 200.

If the polymerization is done in a liquid medium, for example a slurry polymerization, the stronger Lewis acid can be added to the slurry before it enters the polymerization reactor or before or after the slurry is in the polymerization reactor. The supported precursor can be added with the Lewis acid or separately, and can be added to the slurry before or after it enters the polymerization reactor.

If the process is a gas phase polymerization, the precursor and Lewis acid can be added together in a liquid slurry just before being put into the gas phase reactor. A liquid that volatilizes in the reactor can be used, or after mixing, the solid can be filtered from the liquid and added to the reactor.

There are other suitable methods of activating the supported catalyst precursor. A salt, such as a sodium salt or an onium salt of a relatively noncoordinating anion, or a Bronsted acid of a relatively noncoordinating anion, can be mixed with precursor to activate the polymerization. Mixing methods such as those recited hereinabove for the Lewis acid can be used.

By relatively noncoordinating (or weakly coordinating) anions are meant those anions that are generally referred to as such by those skilled in the art. The coordinating ability of such anions is well known and is disclosed, for example, W. Beck et al., Chem. Rev., vol. 88 p. 1405-1421 (1988), and S. H. Stares, Chem. Rev., vol. 93, p. 927-942 (1993), both of which are hereby incorporated herein by reference. Among such anions are those formed from the aluminum compounds described above and X⁻, including R⁹₂AlClX⁻, R⁹AlCl₂X⁻, and “R⁹AlOX⁻”, wherein R⁹ is alkyl. Other useful noncoordinating anions include BAF⁻ {BAF=tetrakis[3,5-bis(trifluoromethyl)phenyl]borate}, (C₆F₅)₄B⁻, SbF₆⁻, PF₆⁻, and BF₄⁻, trifluoromethanesulfonate.

The supported catalysts are useful for polymerization of olefins. Polymerization of olefins, as used herein, includes oligomerization. Also, polymerization, as used herein, includes the formation of homopolymers and copolymers. A preferred olefin for polymerization with the present supported catalysts is ethylene. Other preferred olefins include combinations of ethylene and olefins of the formula R⁸CH═CH₂, wherein R⁸ is n-alkyl, to give an ethylene copolymer. Another preferred combination of olefins is ethylene with an olefin containing a polar group, such as methyl acrylate. It is preferred that ethylene be the only olefin, to form a homopolyethylene. Suitable and preferred catalysts for polymerization of particular olefins are well known to those skilled in the art, and are disclosed in various publications, including U.S. Pat. No. 5,880,241, U.S. Pat. No. 5,932,670, U.S. Pat. No. 5,714,556, U.S. Pat. No. 6,103,658, WO98/47934, WO98/40420, WO00/06620, WO00/18776, WO00/50470 WO00/042257, and WO00/59914. Metal ligand complexes disclosed in these cited documents can be used in the processes disclosed herein, provided the metal ligand complexes are within formula (I).

Aside from the catalyst preparation and activation procedures, the polymerization conditions for the present supported catalysts are the same as reported previously for catalysts disclosed in the aforementioned incorporated references as well as U.S. Pat. No. 5,852,145, U.S. Pat. No. 6,114,483, U.S. Pat. No. 6,526,724, WO97/48735, WO98/56832, WO00/22007, and WO00/50475, all of which are also incorporated by reference herein for all purposes as if fully set forth. Also disclosed therein are the use of olefin polymerization catalysts containing these types of transition metal catalysts, such as the types of polymerization processes that can be used (gas phase, slurry, etc.); modifiers that can be added (e.g., hydrogen); and the use of more than one polymerization catalyst to produce various kinds of polymer products. All of the disclosed processes are equally applicable to the present supported catalysts. For example, more than one transition metal complex may be on the catalyst support.

The polyolefins made in the polymerization processes described herein are useful for a variety of applications, e.g., packaging films and moldings useful for automobiles, appliances, toys, and electrical equipment.

### EXAMPLE 1

The nickel complex used was 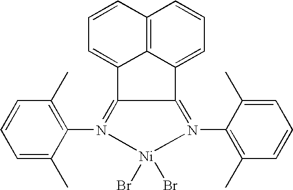
and it was made by procedures described in U.S. Pat. No. 5,880,241.

Grace Davison Silica grade SP9-496 (available from W. R. Grace & Co., Columbia, Md. 21044 USA) which had been calcined at 500° C. was treated with trimethylaluminum (TMA). The silica (8g) was suspended in 40 ml dry toluene. This suspension was gently shaken, and 12 ml of a 2M TMA hexane solution was added. During a period of 2 hours the reaction mixture was gently shaken several times, so as to avoid silica fragmentation. The treated silica was finally washed three times with 40 ml toluene and once with 40 ml pentane. The SiO₂/TMA support was dried in vacuo at 25° C. Then 200 mg of this treated silica was suspended in dichloromethane (4 ml). To this was added a dark brown solution of the NiBr₂-complex (23.1 mg, 3.8 □mol) in dichloromethane (6 ml). The solution immediately became dark green. The reaction mixture was gently shaken several times at room temperature, and the solvent was removed by pipette after 3 hours. The silica was washed with dichloromethane (4×8 ml), and at the 4^{th} washing step the dichloromethane filtrate was almost colorless. The green supported catalyst precursor was dried in vacuo at room temperature for 16 h.

Activation and polymerization was carried out in a mechanically stirred 300 ml Parr® reactor equipped with an electric heating mantle controlled by a thermocouple in the reaction mixture. The reactor was charged with toluene and heated for 10 min at 100° C. The hot toluene was removed, and the reactor was dried under vacuum for 10 min at 100° C. After cooling to room temperature the reactor was filled with argon. The reactor was charged with 50 ml pentane, followed by 0.2 ml Et₃Al₂Cl₃ (0.91 M in toluene) activator. A suspension of the supported catalyst precursor (10 mg) in 50 ml pentane was cannula transferred to the reactor. All lines to the reactor were closed, and the temperature was raised to 60° C. within 5 min while stirring. The reactor was immediately pressurized to 1.03 MPa with ethylene after the desired temperature was reached, and the reaction mixture was stirred for 2 h at 60° C. under 1.03 MPa ethylene pressure. The reaction mixture was cooled to 15° C., and 20 ml methanol was added.

The polymer particles were isolated by filtration, and dried in an oven at 75° C. The 14 g of polymer obtained had melting points of 122° C. and 86° C. (two melting endotherms) as determined by differential scanning calorimetry, had a weight average molecular weight of 131,000 and a number average molecular weight of 33,600 as determined by gel permeation chromatography.

### COMPARATIVE EXAMPLE A

A control experiment was done the same way as Example 1, except no Et₃Al₂Cl₃ was added. No polymer was obtained.

What is claimed is:

1. A process for the formation of a supported olefin polymerization precursor, comprising contacting: an organometallic compound of the formula R¹ₙM, a support that is an inorganic oxide having hydroxyl groups or an organic polymer having hydroxyl groups, and a complex of a Group 8-10 transition metal, with a neutral bidentate ligand that, when activated, forms an active olefin polymerization catalyst, wherein:
each R¹ is independently hydrogen, hydrocarbyl or substituted hydrocarbyl;
n is an integer of 2 to 4 and is the oxidation state of M; and
M is a metal;
and provided that:
said neutral bidentate ligand does not contain a functional group which readily reacts with said organometallic compound;
said support does not contain a support-activator;
and said precursor is inactive.

2. The process of claim 1, further comprising activating said supported olefin polymerization precursor to produce an activated supported polymerization catalyst.

3. The process of claim 2, further comprising contacting said activated supported polymerization catalyst with at least one polymerizable olefin to produce a polyolefin.

4. A product of the process of claim 1.

5. A product of the process of claim 2.

6. The process as recited in claim 1 wherein said neutral bidentate ligand is 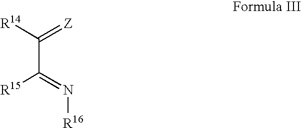
wherein
Z is O or N—R¹³;
R¹³ and R¹⁶ are each independently hydrocarbyl or substituted hydrocarbyl, provided that an atom bound to an imino nitrogen atom has at least two carbon atoms bound to it;
R¹⁴ and R¹⁵ are each independently hydrogen, hydrocarbyl, substituted hydrocarbyl, a heteroatom connected monovalent radical, or R¹⁴ and R¹⁵ taken together form a ring.

7. The process of claim 6, further comprising activating said supported olefin polymerization precursor to produce an activated supported polymerization catalyst.

8. The process of claim 7, further comprising contacting said activated supported polymerization catalyst with at least one polymerizable olefin to produce a polyolefin.

9. A product of the process of claim 6.

10. A product of the process of claim 7.
